(19) United States
(12) Patent Application Publication
(10) Pub. No.: US 2007/0188157 A1
(43) Pub. Date: Aug. 16, 2007

(54) HIGH-VOLTAGE POWER SUPPLY UNIT

(76) Inventor: Nobuhiko Hatano, Osaka-shi (JP)

Correspondence Address: WENDEROTH, LIND & PONACK, L.L.P., 2033 K STREET N. W., SUITE 800, WASHINGTON, DC, 20006-1021, US

(21) Appl. No.: 10/581,620

(22) PCT Filed: Dec. 8, 2004
(86) PCT No.: PCT/JP04/18678

§ 371 Date: Mar. 26, 2007

(30) Foreign Application Priority Data
Dec. 22, 2003 (JP) 2003-425029

(51) Int. Cl. H01F 21/00

(52) U.S. Cl. 323/355

(57) ABSTRACT

It is intended to reduce a size and a cost of a high-voltage power supply unit applied to an electrophotographic image forming apparatus and a neon billboard, The high-voltage power supply includes at least a high-voltage transformer and a driving circuit for driving the high-voltage transformer and supplies power to a load connected to a secondary side of the high-voltage transformer. The high-voltage power supply further includes: a high-voltage switching circuit for switching polarity of a DC output voltage generated on the secondary side of the high-voltage transformer; and a control circuit for controlling switching by the high-voltage switching circuit based on a load current that is caused to flow by application of the DC current output voltage.

### BACKGROUND OF THE INVENTION

1. Field of the Invention

The present invention relates to a power supply unit for supplying power to a plurality of high-voltage loads such as an electrophotographic image forming apparatus, e.g., a copier, a laser printer, and a laser facsimile machine, and a neon billboard including a plurality of combined neon tubes.

2. Description of the Related Art

An electrophotographic image forming apparatus is provided with a high-voltage power supply. The high-voltage power supply is essential for a process for forming an image on paper or the like. Specification of the high-voltage power supply is different between respective processes in the image forming process such as a charge process, a transfer process, and a separation process.

Charge in the image forming process is a process for charging a photoconductor by causing corona discharge. Examples of a material for the photoconductor include selenium, amorphous semiconductor, and organic semiconductor. Polarity of a charging high-voltage power supply should be chosen in accordance with the material for the photoconductor.

Transfer in the image forming process is a process for moving toner particles adhering to the photoconductor to recording paper after formation of a latent image and fixing. This transfer requires a high-voltage power supply of opposite polarity to that of the power supply used in the charge.

Moreover, a high-voltage power supply may be used in a process for removing toner particles remaining on the photoconductor and a process for separating the recording paper sticking to the photoconductor from the photoconductor. The latter process requires an AC high-voltage power supply with a DC bias because that process aims to electrically neutralize the recording paper.

FIG. 7 shows an example of a conventional high-voltage power supply unit. 1 denotes an image forming apparatus. 2 denotes a CPU. 3 denotes a high-voltage transformer. 4 denotes a transformer driving circuit for switching the high-voltage transformer 3. 5 denotes a fusing resistor 6 denotes a transistor for controlling power supplied to the high-voltage transformer 3. 7 denotes an electrolytic capacitor. 8 denotes a constant voltage control circuit. 9 denotes a snubber diode. 10 denotes a high-voltage diode. 11 denotes a high-voltage capacitor. 12 denotes a bleeder resistor. 101 denotes a high-voltage transformer having an auxiliary winding for detecting an output voltage. 14 denotes a transformer driving circuit for switching the high-voltage transformer 101. 15 denotes a fusing resistor. 16 denotes a transistor for controlling power supplied to the high-voltage transformer 101. 17 denotes an electrolytic capacitor. 18 denotes a constant voltage control circuit. 19 denotes a snubber diode. 102 denotes an output voltage detection unit for detecting the output voltage by the auxiliary winding of the high-voltage transformer 101. 20 denotes a high-voltage diode. 21 denotes a high-voltage capacitor. 22 denotes a bleeder resistor. 23 and 24 denote resistors for output voltage detection 25 denotes an AC grounding capacitor. 26 denotes an operation amplifier for detecting a load current 27 denotes a resistor for detecting a load current. 28 denotes a phase compensating capacitor. 29 denotes a DC power supply. 30 denotes a resistor for current limitation. 31 denotes a load.

An operation for outputting a positive voltage in this high-voltage power supply unit will now be described. First, the CPU 2 outputs CLK having a predetermined frequency/duty ratio. CLK is sent to the transformer driving circuit 4 which in turn switches the high-voltage transformer 3. The high-voltage transformer 3 raises a voltage input thereto to generate a high voltage having a predetermined pulse-like waveform. The high voltage having the predetermined pulse-like wave-form thus generated is rectified by the high-voltage diode 13 and the high-voltage capacitor 11, so that a positive high-voltage DC bias is generated.

The CPU 2 then outputs a voltage corresponding to a desired high output voltage to the constant voltage control circuit 8 from a D/A port 1. The output voltage is detected by voltage dividing by the detecting resistors 23 and 24. The constant voltage control circuit 8 controls the transistor 6 to make the detected output voltage and a value of the voltage from the D/A port 1 of the CPU 2 equal to each other and controls the voltage input to the high-voltage transformer 3.

CLK from the CPU 2 is also input to the transformer driving circuit 14 for outputting a negative voltage and then the high-voltage transformer 101 is switched. However, a voltage output from a D/A port 2 is set so as to prevent generation of an output of the constant voltage control circuit 18, thereby preventing voltage supply to the transformer 101 and generation of a high-voltage output in the high-voltage transformer 101.

Next, an operation for outputting a negative voltage in the high-voltage power supply unit will be described. The CPU 2 outputs CLK having a predetermined frequency/duty ratio. CLK is sent to the transformer driving circuit 14 which in turn switches the high-voltage transformer 101. The high-voltage transformer 101 raises a voltage input thereto so as to generate a high voltage having a predetermined pulse-like waveform. The high voltage having the predetermined pulse-like waveform thus generated by the transformer 101 is rectified by the high-voltage diode 20 and the high-voltage capacitor 21, so that a negative high-voltage DC bias is generated. The thus generated high-voltage bias is applied to the load 31 via the bleeder resistor 12.

The CPU 2 then outputs a voltage corresponding to a desired high-voltage output voltage to the constant voltage control circuit 18 from the D/A port 2. The output voltage is detected by the auxiliary winding of the high-voltage transformer 101 and the output voltage detecting unit 102. The constant voltage control circuit 18 controls the transistor 16 so as to make the thus detected output voltage and a value of the voltage from the D/A port 2 of the CPU 2 equal to each other and controls the voltage input to the high-voltage transformer 101.

CLK from the CPU 2 is also input to the transformer driving circuit 4 having a negative voltage. However, an output voltage of the D/A port 1 is set so as to prevent generation of the output of the constant voltage control circuit 8, thereby preventing voltage supply to the high-voltage transformer 3 and preventing the transformer 3 from generating a high-voltage output (see Japanese Patent Laid-Open Publication No. 2003-209972, for example).

An exemplary high-voltage power supply unit applied to a neon billboard will now be described as another background art. The neon billboard includes many neon tubes and uses a neon inverter transformer for flashing and dimming of the neon tubes. This type of neon inverter transformer has to output a high voltage for exciting neon or argon in order to light a discharge tube in which neon or argon gas is enclosed.

FIG. 8 shows an exemplary neon inverter transformer. The neon inverter transformer includes transistors Tr1 and Tr2 as a primary-side oscillation circuit. Commercial power 1 that is an AC power supply is converted into a direct current by a rectification circuit 2. A primary coil 3 is alternately switched by the transistors Tr1 and Tr2 at a predetermined frequency. In this manner, a high-voltage alternating current having a high frequency is generated in a secondary coil 5. The thus generated high-voltage alternating current is supplied to an electrode of a neon tube 6 (see Japanese Patent Laid-Open Publication No. Hei 9-35886, for example).

The aforementioned conventional high-voltage power supply unit applied to the image forming apparatus requires a plurality of high-voltage transformers and driving circuits for types of output voltages, respectively, e.g., for switching polarity of an output voltage. Moreover, the conventional high-voltage power supply unit applied to the neon billboard requires the same number of transformers as the neon tube groups, because the neon billboard is formed by a number of neon tubes that are divided into several groups and are controlled group by group and a waveform of a voltage supplied to a load is adjusted on a lower-voltage side. The conventional high-voltage power supply unit applied to the image forming apparatus or the neon billboard as described above has a problem of increase in size and cost.

### SUMMARY OF THE INVENTION

Therefore, it is an object of the present invention to reduce a size and a cost of a high-voltage power supply unit applied to an electrophotographic image forming apparatus and a neon billboard.

According to the present invention, a high-voltage power supply that includes at least a high-voltage transformer and a driving circuit for driving the high-voltage transformer and supplies power to load connected to a secondary side of the high-voltage transformer is provided with a high-voltage switching circuit for switching polarity of a DC output voltage generated on the secondary side of the high-voltage transformer and a control circuit for controlling switching by the high-voltage switching circuit based on a load current that is caused to flow by application of the DC current output voltage. The phrase “at least” is used to mean that the required number of high-voltage transformers and driving circuits can be made smaller than ever before and the high-voltage power supply of the present invention requires a minimum number of high-voltage transformers and driving circuits. It is preferable that one pair of the high-voltage transformer and the driving circuit be enough. The phrase “includes (at least) a high-voltage transformer and a driving circuit for driving the high-voltage transformer” is used to mean that the high-voltage power supply of the present invention includes a component other than the high-voltage transformer and the driving circuit. It is desirable that the high-voltage switching circuit have a full-bridge structure using a wide band gap semiconductor device as a switching device. It is more preferable that the high-voltage switching circuit use a wide band gap semiconductor device using SiC as a base material.

According to the present invention, the control circuit controls switching performed by the high-voltage switching circuit. Due to this, it is possible to switch the polarity of the DC output voltage generated on the secondary side of the high-voltage transformer by the high-voltage switching circuit and supply a positive or negative voltage to the load by means of a smaller number of high-voltage transformers and driving circuits than ever before. Moreover, the DC output voltage generated on the secondary side of the high-voltage transformer can be converted into an AC output voltage having a rectangular waveform by performing PWM control for the high-voltage switching circuit by the control circuit. As a result, in a power supply unit of an image forming device or a neon billboard to which the present invention is applied, a high-voltage power supply portion can be simplified. Therefore, the power supply unit can be formed to be compact at a low cost.

The high-voltage power supply unit of the present invention is suitable for use as a power supply unit for an image forming apparatus and is used in at least one of a charge process for charging a photoconductor of the image forming apparatus, a transfer process for moving a toner image formed on a surface of the photoconductor to recording paper, and a separation process for electrically neutralizing the recording paper sticking to the photoconductor.

Moreover, when a structure in which a plurality of pairs of the high-voltage switching circuit and the control circuit are connected in parallel on the secondary side of the high-voltage transformer is employed, it is possible to easily apply the high-voltage power supply unit of the present invention to a neon billboard including many combined neon tubes.

### BRIEF DESCRIPTION OF THE DRAWINGS

FIG. 1 is a circuit diagram of a high-voltage power supply unit according to an embodiment of the present invention;

FIG. 2 is a circuit diagram of a switch control circuit shown in FIG. 1;

FIG. 3 shows waveforms at various portions for showing an exemplary operation of the high-voltage power supply unit;

FIG. 4 shows a general structure of a typical electrophotographic image forming apparatus for explaining an exemplary application of the high-voltage power supply unit;

FIG. 5 is a cross-sectional view showing an exemplary wide band gap semiconductor device applied to a high-voltage switch of a high-voltage switching circuit;

FIG. 6 is a circuit block diagram showing a structure of a high-voltage power supply unit used as a power supply unit of a neon billboard including a plurality of neon tubes.

FIG. 7 is a circuit block diagram showing an exemplary conventional high-voltage power supply unit; and

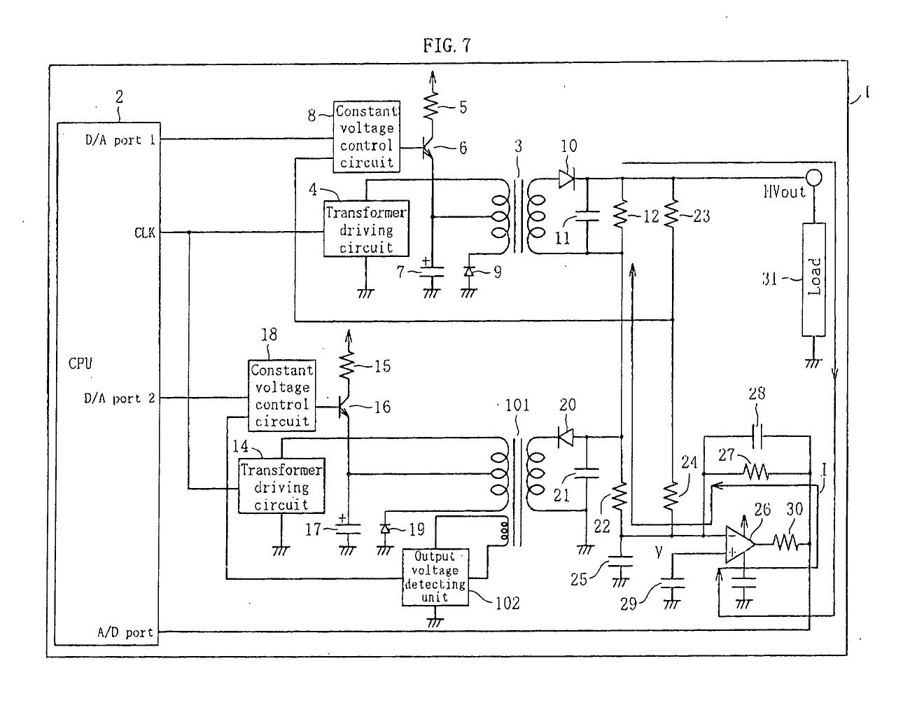

FIG. 8 is a circuit block diagram showing another exemplary conventional high-voltage power supply unit.

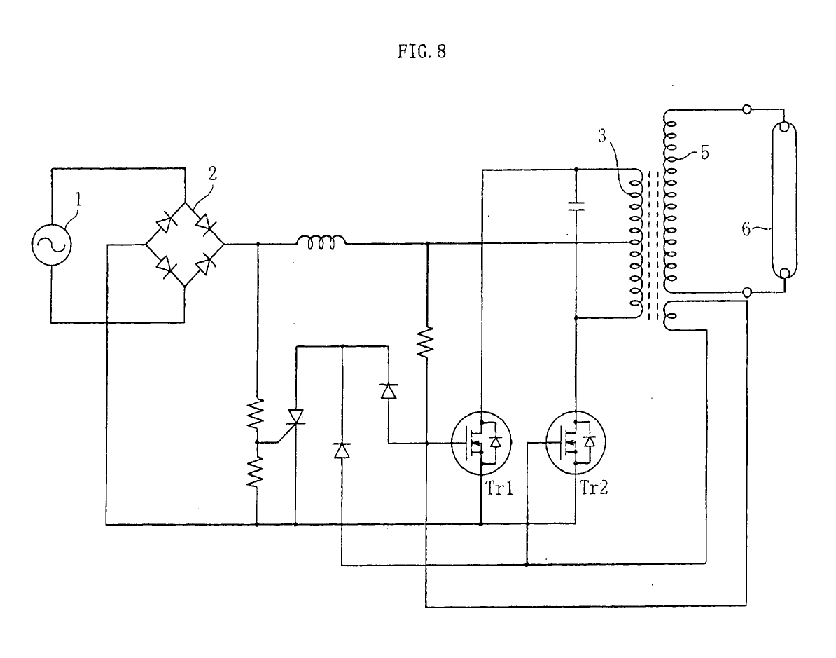

### DETAILED DESCRIPTION OF THE PREFERRED EMBODIMENTS

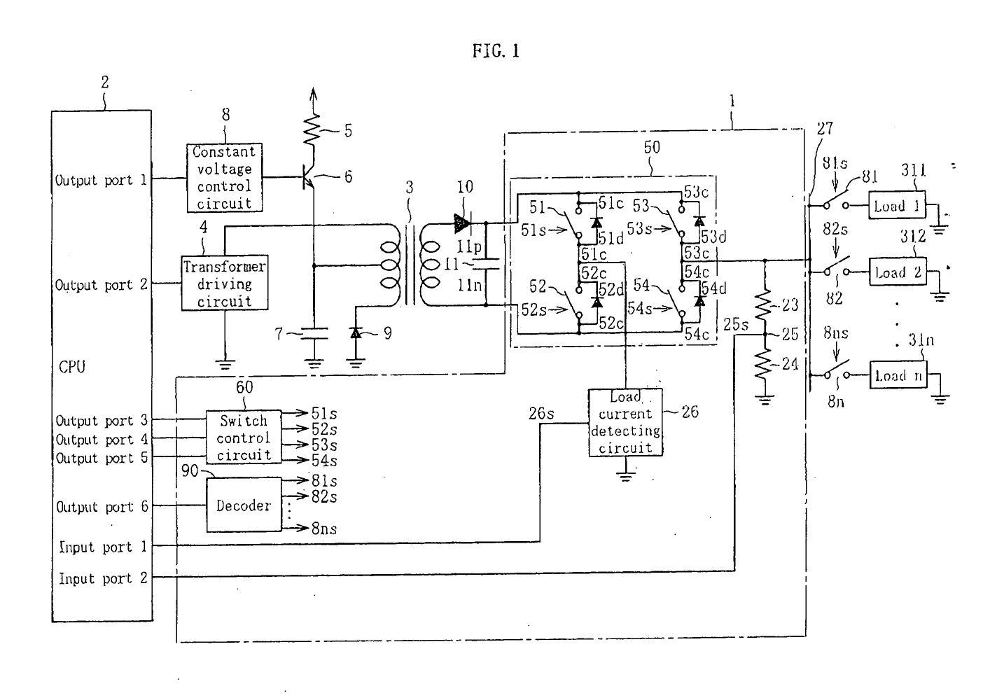

FIG. 1 shows a structure of a high-voltage power supply unit according to an embodiment of the present invention. 1 denotes the high-voltage power supply unit. 2 denotes a CPU. 3 denotes a high-voltage transformer. 4 denotes a transformer driving circuit for switching the high-voltage transformer 3. 5 denotes a fusing resistor. 6 denotes a transistor for controlling power supplied to the high-voltage transformer 3. 7 denotes an electrolytic capacitor. 8 denotes a constant voltage control circuit. 9 denotes a snubber diode. 10 denotes a high-voltage diode. 11 denotes a high-voltage capacitor. 23 and 24 denote resistors for detecting an output voltage. 26 denotes a circuit for detecting a load current. 27 denotes a common bus. 31l to 31n denote loads. 50 denotes a high-voltage switching circuit. 51 to 54 denote high-voltage switches 31d to 54d denote high-voltage diodes. 51s to 54s denote control signals for the high-voltage switches. 60 denotes a switch control circuit. 8l to 8n denote load selecting switches. 8ls to 8ns denote control signals for the load selecting switches. 90 denotes a decoder.

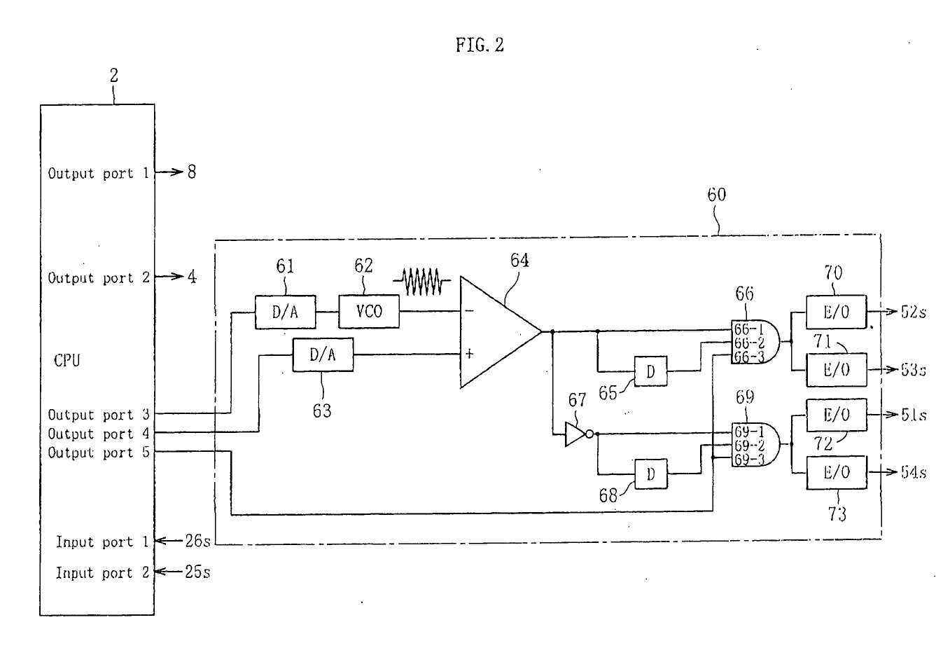

FIG. 2 is a block diagram of the switch control circuit 60. 61 denotes a D/A converter. 62 denotes a triangular wave generation unit. 63 denotes a D/A converter. 64 denotes a comparator. 65 denotes a delay circuit. 66 denotes an AND circuit. 67 denotes an inverting circuit. 68 denotes a delay circuit. 69 denotes an AND circuit. 70 to 73 denote E/O conversion circuits.

An operation of the high-voltage power supply unit will now be described. An operation until the high-voltage capacitor 11 is charged is the same as that of the conventional high-voltage power supply unit described before. In other words, the CPU 2 outputs CLK having a predetermined frequency/duty ratio from an output port 2 as shown in FIG. 1. CLK is sent to the transformer driving circuit 4 which in turn switches the high-voltage transformer 3. The high-voltage transformer 3 raises a voltage input thereto, thereby generating a high voltage having a predetermined pulse-like waveform. The high voltage having the predetermined pulse-like waveform thus generated by the transformer 3 is rectified by the high-voltage diode 10 and the high-voltage capacitor 11, so that a positive high-voltage DC bias is generated. The CPU 2 then outputs a voltage corresponding to a desired high output voltage to the constant voltage control circuit 8 from an output port 1. The output voltage is detected by voltage division by the detecting resistors 23 and 24. Although input of the output voltage divided by the resistors 23 and 24 to the constant voltage control circuit 8 is omitted, a control signal that is generated by arithmetic processing of an output signal 25s within the CPU 2 is input to the constant voltage control circuit 8. The constant voltage control circuit 8 controls the transistor 6 so as to make the detected output voltage equal to a value of the voltage from the output port 1 of the CPU 2 and controls the voltage input to the high-voltage transformer 3.

As shown in FIG. 2, an output from an output port 3 of the CPU 2 is converted into an analog voltage by the D/A converter 61. Then, the triangular wave generation unit 62 generates a triangular wave having a fixed peak value and a frequency determined in accordance with a value of the above analog voltage. An output port 5 of the CPU 2 usually generates a positive voltage corresponding to logical true. When the CLU 2 detects an abnormal state, the output port 3 generates a zero voltage corresponding to logical false.

When applying a positive DC voltage to at least one of the loads 3ll to 3ln, a signal for opening all the load selecting switches 8l to 8n once is output from an output port 6 of the CPU 2. Then, a digital signal for making an output of the D/A converter 63 larger than a positive peak value of the triangular wave generation unit 62 is output from an output port 4 of the CPU 2. The comparator 64 compares the outputs of the triangular wave generation unit 62 and the D/A converter 63 with each other and then generates a positive voltage corresponding to logical true. An input 66-1 of the AND circuit 66 has the same value as an output of the comparator 64. An input 66-2 outputs a positive value after a delay time determined by the delay circuit 65 irrespective of a state before the output of the comparator 64 becomes positive. The output port 5 usually outputs a positive value, as described before. Thus, when the output of the comparator 64 is a positive voltage, the AND circuit 66 outputs a positive voltage corresponding to logical true after the delay time provided by the delay circuit 65. The delay circuit 65 and the other delay circuit 68 that will be described later are provided in order to prevent both the outputs of the AND circuits 66 and 69 from being positive instantaneously.

Upon receiving the output of the AND circuit 65, the E/O conversion circuits 70 and 71 output optical signals 52s and 53s corresponding to logical true, thus making the switches 52 and 53 electrically continuous, respectively. On the other hand, an input 69-1 of the AND circuit 69 has a different logical state from the output of the comparator 64 due to the inverting circuit 67. Thus, when the output of the comparator 64 becomes positive, an output of the AND circuit 69 becomes negative at the same time, and opens the switches 51 and 54 via E/O converter.

The above operation realizes electrical continuity from a terminal lip to the common bus 27 via the switch 53 and from ground to a terminal 11n via the load current detection circuit 26 and the switch 52. Therefore, a positive voltage is supplied to the common bus 27. After confirming that the voltage of the common bus 27 becomes stable based on a signal 25s, the CPU 2 outputs a signal specifying at least one load from the output port 6 so as to make a specified one or more of load selecting switches 8l to 8n electrically continuous by, outputting corresponding one or more of the load selecting signals 8ls to 8ns via the decoder 90. In this manner, it is possible to supply a positive DC voltage to the specified one or more of the loads 3ll to 3ln.

When supplying a negative DC voltage to at least one of the loads 3ll to 3ln, the CPU 2 outputs, from the output port 4, a digital signal that makes the output of the D/A converter 63 lower than a negative peak value of the triangular wave generation unit 62. Except for this point, the operation this case is the same as that in the case of supplying a positive voltage.

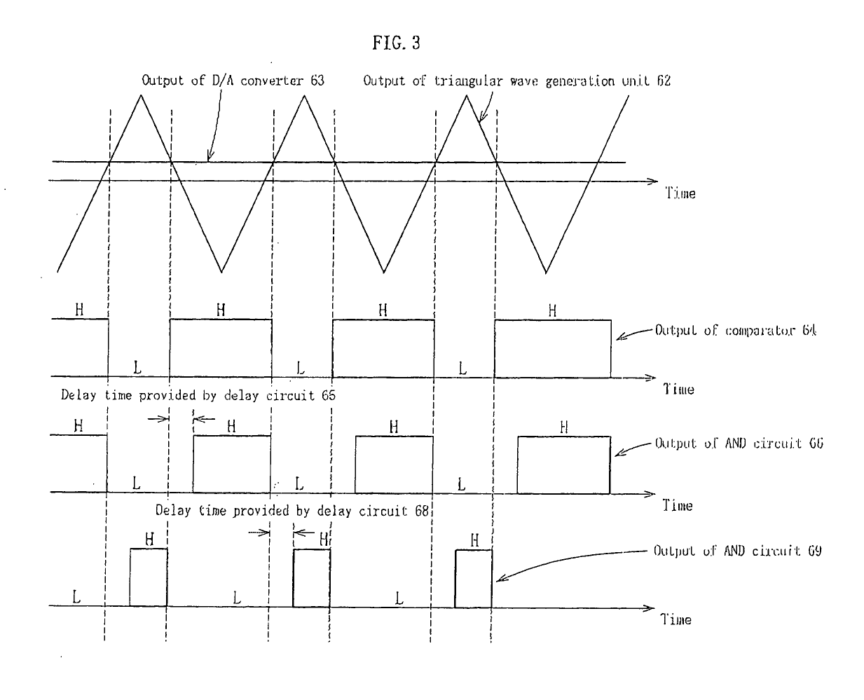

This high-voltage power supply unit can also perform an operation for supplying an AC voltage having a rectangular waveform to at least one of the loads 3ll to 3ln. In this operation, the CPU 2 outputs a digital signal that makes the output of the D/A converter 63 have a value in a range from the negative peak value to the positive peak value of the triangular wave generation unit 62. An example of this operation is shown in FIG. 3 that shows waveforms. The output of the comparator 64 is a positive voltage at a time at which the output value of the D/A converter 63 is larger than the output value of the triangular wave generation unit 62, and is a negative voltage at a time at which the output value of the D/A converter 63 is smaller than the output value of the triangular wave generation unit 62.

In other words, the output of the comparator 64 alternately has a positive value and a negative value in terms of time, which are determined by an output frequency of the triangular wave generator unit 62 determined by the output signal from the output port 3 of the CPU 2, and a duty ratio determined by a magnitude relationship between the output value of the D/A converter 63 determined by the output signal from the output port 4 of the CPU 2 and the output value of the triangular wave generation unit 62.

The relationship between the output of the comparator 64 and the voltage supplied to the loads 3ll to 3ln in this case is the same as that in the aforementioned case. Except for the above, the operation in this case is the same as that in the case of supplying a positive or negative voltage. By outputting a control signal from the CPU 2 in the above manner, it is possible to supply an AC voltage having a rectangular waveform to the loads 3ll to 3ln, too.

Please note that the phrase “at least one of the loads 3ll to 3ln” is used in the description of application of a positive DC voltage, a negative DC voltage, or an AC voltage having a rectangular waveform to the loads 3ll to 3ln in order to mean both the case where the voltage is supplied to only one load and the case where the voltage is supplied to two or more loads among the loads 3ll to 3ln.

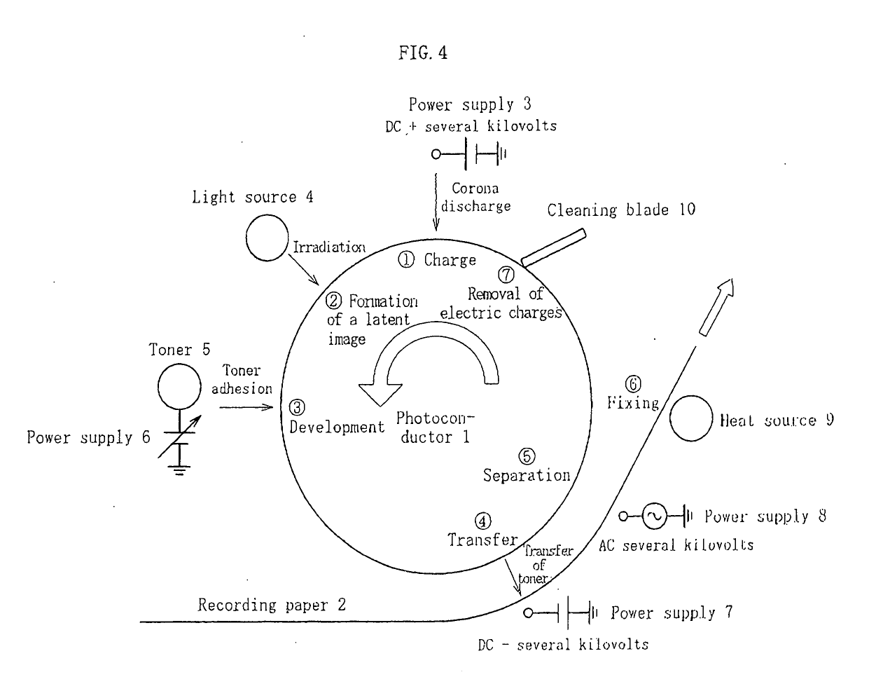

An exemplary application of the above high-voltage power supply unit will now be described. FIG. 4 shows an example or a typical electrophotographic image forming apparatus that basically prints an image by performing charge, formation of a latent image, development, transfer, separation, fixing, and, removal of electric charges.

Charge is a process for charging a photoconductor by corona discharge using a 5 kV high-voltage DC power supply. In the example of FIG. 4, polarity of the power supply is assumed to be positive. A voltage value of the DC power supply is determined in accordance with a material for the photoconductor, a structure of the apparatus, and other factors, and is not specifically limited to the above value. Formation of a latent image is a process for irradiating the charged photoconductor with light to remove electric charges, thereby forming a charge pattern (electrostatic latent image) on the photoconductor in accordance with an image to be printed. Development is a process for making toner particles adhere to the electrostatic latent image formed on a surface of the photoconductor to obtain a visible image. This process uses a variable power supply that can provide hundreds of volts in order to move toner particles. Transfer is a process for moving a toner image formed on the surface of the photoconductor to recording paper. This processes requires a high-voltage DC power supply that can provide a voltage having opposite polarity to that in the charge process and approximately the same magnitude as that provided in the charge process. Separation is a process for electrically neutralizing the recording paper by means of a high-voltage AC power supply having a frequency of about 1 kHz in order to remove the recording paper sticking to the photoconductor from the photoconductor. Fixing is a process for fixing the toner particles to the recording paper by heating and does not use a high-voltage power supply. Removal of electric charges is a process for removing the toner particles remaining on the photoconductor. As described above, in an electrophotographic method, an image is basically printed by performing charge, formation of a latent image, development, transfer, separation, fixing, and removal of electric charges. In particular, charge, transfer, and separation require high-voltage power supplies.

In the example of FIG. 4, the photoconductor is rotated in a counterclockwise direction and the recording paper is moved from left to top right in FIG. 4 (see outline arrow in FIG. 4). In each of the aforementioned processes, it is necessary to synchronize the position of a photoconductor and the position of recording paper with each other in order to print a desired image on the recording paper. However, there is no temporal constraint. Therefore, if a precise stepping motor is used for rotating the photoconductor and moving the recording paper, for example, an image can be formed on the recording paper by repeating the following operations; performing the charge, transfer, and separation processes that use the high-voltage power supply unit in a time-division manner while the rotation of the photoconductor and the movement of the recording paper are temporarily stopped, and performing one or more of latent image formation, development, fixing, and electric charge removal that are determined to be necessary based on the positional relationship between the photoconductor and the recording paper while rotating the photoconductor and moving the recording paper to place them at their next positions.

The high-voltage power supply unit shown in FIGS. 1 and 2 can be applied to that image forming apparatus by setting a charging voltage of the capacitor 11 to 5 kV. However, the high-voltage switches 51 to 54 and the load selecting switches 81 to 83 (the loads 1, 2, and 3 correspond to charge, transfer, and separation in the aforementioned case, respectively) should have a withstand voltage of about 8 kV in order to deal with a transient overvoltage during a switching operation in addition to 5 kV from the DC power supply. Moreover, the high-voltage switches 51 to 54 should use switching devices that can operate at a switching frequency of about 1 kHz. Those switches can be formed by connecting seven IGBTs having a withstand voltage of 1.2 kV that are widely used in series, for example. In this manner, the electrophotographic image forming apparatus described above can be achieved. As described above, due to the use of the aforementioned high-voltage power supply unit, it is possible to simplify a high-voltage power supply portion in the image forming apparatus and form the electrophotographic image forming apparatus to be compact at a low cost.

It is preferable to use a wide band gap semiconductor device as each of the high-voltage switches 51 to 54 in the high-voltage switching circuit 50. The wide band gap semiconductor device using SiC (silicon carbide), GaN (gallium nitride), or diamond as a base material has a dielectric breakdown voltage about 10 times as high as that of a semiconductor device using Si and therefore is considered to be suitable for achieving a device having a high withstand voltage. Among the above-listed base materials, for SiC, a semiconductor device having a withstand voltage higher than 10 kV has been already realized.

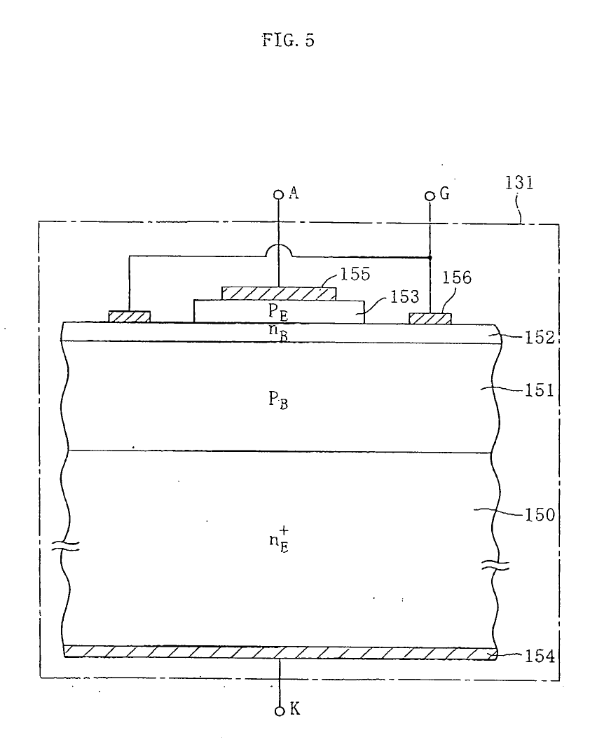

FIG. 5 shows a cross section of an anode gate type SiC GTO chip 131 having a rated voltage of 8 kV. In this GTO chip 131, a p-type base layer 151, an n-type base layer 152, and a p-type emitter layer 153 are formed in that order on an upper surface of an n-type SiC substrate 150 serving as an emitter. A cathode electrode 154 is provided on a lower surface of the substrate 150. An anode electrode 155 is provided on the p-type emitter 153. An anode gate electrode 135 is provided on the n-type base layer 152.

The GTO chip 131 is turned on by making a driving current flow from an anode A to an anode gate G. After the GTO chip 131 is turned on, when a current flowing between a cathode K and the anode A is diverted to flow between the cathode K and the anode gate G, the GTO chip 131 is turned off. A thickness of each layer in the GTO chip 131 is set in the following manner. For example, the substrate 150 has a thickness of approximately 400 microns, the p-type base layer 151 has a thickness of approximately 80 microns, the n-type base layer 152 has a thickness of approximately 3 microns, and the p-type emitter layer 153 has a thickness of approximately 5 microns. In this case, a gate turn-on current and a gate turn-off current of the GTO thyristor can be largely reduced by providing the anode gate electrode 156 on the n-type base layer 152, as shown in FIG. 5, to perform anode-gate driving, as compared with the case where the anode gate electrode 156 is provided on the p-type base layer 151 to perform cathode gate driving. Thus, an output of a driving power that is not shown can be realized with small power and therefore large reduction in size and weight can be achieved.

When SiC device and an Si device both of which have the same withstand voltage are compared with each other, a thickness of a field relaxation layer in the SiC device can be reducer to about 1/10 for the aforementioned reason. This, a switching time of a GTO using SiC is shorter than a GTO using Si by at least one digit because of a difference of a carrier's travel distance. Therefore, the GTO using SiC can handle a switching frequency about 10 times as high as that handled by the GTO using Si. Moreover, minor carriers have a shorter life in the SiC device than in the Si device. Thus, further increase in the switching rate can be achieved. This means that the GTO using SiC can handle a switching frequency of 2 kHz or higher because the GTO using Si is usually used for a switching frequency of about 200 Hz. For the same reasons, a high-speed operation can be achieved in the high-voltage diodes 51d to 54d (see FIG. 1) connected to the high-voltage switches in anti-parallel connection by applying pn diodes using SiC to the respective high-voltage diodes 51d to 54d.

The aforementioned image forming apparatus is based on the use of a switching device that has a withstand voltage of 8 kV and can handle a switching frequency of about 1 kHz. When a 1.2 kV class Si-IGBT is used in that image forming apparatus, it is necessary to use a number of Switching devices that are connected in series. On the other hand, when the aforementioned GTO using SiC is used for each of the high-voltage switches 51 to 54 and load selecting switches 81 to 83 and the pn diode using SiC is used for each of the high-voltage diodes 51d to 54d and high-voltage diode 75, each switch can be realized by one series of semiconductor device.

As described above, the use of a semiconductor device using SiC for each of the high-voltage switches and load selecting switches in the high-voltage power supply unit can simplify circuitry and improve reliability. Therefore, the object of the present invention, i.e., reduction in size and cost of the high-voltage power supply unit can be achieved more effectively. Moreover, due to the feature of the high-speed switching, high-speed image formation can be achieved, i.e., a printing speed of a printer can be increased.

The high-voltage power supply unit 1 shown in FIGS. 1 and 2 can output a sinusoidal voltage waveform and a given voltage waveform in accordance with an instructed value from the output port 4 of the CPU 2 by performing PWM control using the rectangular AC voltage generation function. Those voltage waveforms contain high frequencies caused by switching by the high-voltage switches 5l to 5n. However, it is possible to easily take measures against the high frequencies by inserting a low-pass filter between a load selecting switch and a load associated therewith, e.g., between the load selecting switch 81 and the load 3ll, or example. Therefore, the high-voltage power supply unit 1 can be applied to a load that requires continuous control for an output voltage.

An example in which the high-voltage power supply unit is applied to a neon billboard will now be described.

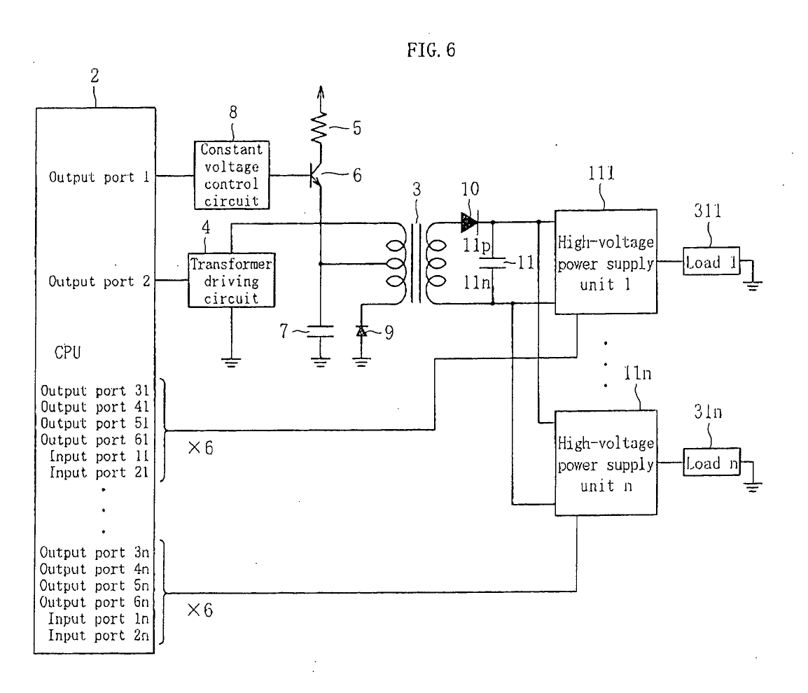

In this example as shown in FIG. 6, a DC power supply is used as the capacitor 11, the high-voltage power supply units 11l to 11n of the present invention are connected in parallel on a load side of the DC power supply, flashing and dimming are independently controlled, and high-voltage power is supplied to loads 3ll to 3ln corresponding to neon tube groups. Of course there are limited numbers of input and output ports of the CPU 2. However, it is possible to easily take measures against that limitation, for example, to perform time-division processing or provide a buffer circuit. As described above, due to the use of the high-voltage power supply units 11l to 11n, it is possible to simplify a high-voltage power supply portion in the neon billboard and form the neon billboard to be compact at a low cost.

Moreover, lighting of a neon tube usually requires a voltage as high as about 10 kV and therefore each high-voltage switch and each diode in the high-voltage power supply units 11l to 11n should have a withstand voltage that can handle such a high voltage. In addition, dimming can be easily performed by PWM control. However, it is desirable that a higher switching frequency be obtained in order to improve precision. For those two reasons, the object of the present invention can be achieved more effectively by using the aforementioned SiC semiconductor device for each high-voltage switch and each diode in the high-voltage power supply unit.

The present invention is not limited to the aforementioned embodiments but can be modified and applied in various ways. For example, the semiconductor switching device using SiC is not limited to the GTO but may be IGBT, an npn transistor, a MOSFET, or the like. Similarly, the high-voltage diode connected in anti-parallel connection with respect to the high-voltage switch may be formed by a Schottky diode using SiC. Furthermore, another wide band gap semiconductor device using GaN or the like may be used for the switching devices and diodes.

1. A high-voltage power supply that includes at least a high-voltage transformer and a driving circuit for driving the high-voltage transformer and supplies power to a load connected to a secondary side of the high-voltage transformer, further comprising:
a high-voltage switching circuit for switching polarity of a DC output voltage generated on the secondary side of the high-voltage transformer; and
a control circuit for controlling switching by the high-voltage switching circuit based on a load current that is caused to flow by application of the DC current output voltage.

2. A high-voltage power supply according to claim 1, wherein a plurality of pairs of the high-voltage switching circuit and the control circuit are connected in parallel on the secondary side of the high-voltage transformer.

3. A high-voltage power supply according to claim 1, wherein the DC output voltage generated on the secondary side of the high-voltage transformer is converted into an AC output voltage having a rectangular waveform by performing PWM control for the high-voltage switching circuit by the control circuit.

4. A high-voltage power supply according to claim 1, wherein the high-voltage switching circuit has a full-bridge structure using a wide band gap semiconductor device as a switching device.

5. A high-voltage power supply according to claim 4, wherein the wide band gap semiconductor device comprises SiC as a base material.

6. A high-voltage power supply according to claim 1, wherein the load is an image forming apparatus and wherein the high-voltage power supply is used in at least one of a charge process for charging a photoconductor of the image forming apparatus, a transfer process for moving a toner image formed on a surface of the photoconductor to recording paper, and a separation process for electrically neutralizing the recording paper sticking to the photoconductor.

7. A high-voltage power supply according to claim 2, wherein the DC output voltage generated on the secondary side of the high-voltage transformer is converted into an AC output voltage having a rectangular waveform by performing PWM control for the high-voltage switching circuit by the control circuit.

8. A high-voltage power supply according to claim 2, wherein the high-voltage switching circuit has a full-bridge structure using a wide band gap semiconductor device as a switching device.

9. A high-voltage power supply according to claim 3, wherein the high-voltage switching circuit has a full-bridge structure using a wide band gap semiconductor device as a switching device.

10. A high-voltage power supply according to claim 2, wherein the load is an image forming apparatus and wherein the high-voltage power supply is used in at least one of a charge process for charging a photoconductor of the image forming apparatus, a transfer process for moving a toner image formed on a surface of the photoconductor to recording paper, and a separation process for electrically neutralizing the recording paper sticking to the photoconductor.

11. A high-voltage power supply according to claim 3, wherein the load is an image forming apparatus and wherein the high-voltage power supply is used in at least one of a charge process for charging a photoconductor of the image forming apparatus, a transfer process for moving a toner image formed on a surface of the photoconductor to recording paper, and a separation process for electrically neutralizing the recording paper sticking to the photoconductor.

12. A high-voltage power supply according to claim 4, wherein the load is an image forming apparatus and wherein the high-voltage power supply is used in at least one of a charge process for charging a photoconductor of the image forming apparatus, a transfer process for moving a toner image formed on a surface of the photoconductor to recording paper, and a separation process for electrically neutralizing the recording paper sticking to the photoconductor.

13. A high-voltage power supply according to claim 5, wherein the load is an image forming apparatus and wherein the high-voltage power supply is used in at least one of a charge process for charging a photoconductor of the image forming apparatus, a transfer process for moving a toner image formed on a surface of the photoconductor to recording paper, and a separation process for electrically neutralizing the recording paper sticking to the photoconductor.
